(19) United States
(12) Patent Application Publication
(10) Pub. No.: US 2008/0280615 A1
(43) Pub. Date: Nov. 13, 2008

(54) Method and apparatus ensuring application quality of service

(75) Inventor: Preetida Vinayakray-Jani, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/902,664

(22) Filed: Sep. 24, 2007

(30) Foreign Application Priority Data
May 11, 2007 (GB) 0709125.9

(51) Int. Cl. H04Q 7/20

(52) U.S. Cl. 455/437

(57) ABSTRACT

A method and apparatus for ensuring application of quality of service requirements on an access network. The method includes comparing, in a mobile communication device, one or more application signaling requirements of a selected application with one or more link characteristics of a link between the mobile communication device and an access node of an access network. Based on the comparison, the method further includes selecting at least one of: signaling, in the mobile communications device, to a handover algorithm to indicate that a handover to another access node is desired if it is determined that the application signaling requirements cannot be met by the link; and determining, in the mobile communication device, one or more transmission characteristics for the selected application based on the one or more application signaling requirements and the one or more link characteristics, and transmitting a signal from the mobile communication device to the access node for the selected application using the determined one or more transmission characteristics if it is determined that the application signaling requirements can be met by the link.

### FIELD OF THE INVENTION

Embodiments of the present invention relate to a method of ensuring application quality of service requirements on an access network. Embodiments also relate to a communication system comprising one or more access networks utilizing the aforementioned method and a mobile communication device for use with the access networks. Certain embodiments also relate to handover of a mobile communication device between at least two access nodes of the communication system.

### BACKGROUND

A mobile communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various applications.

A communication system is a facility which supports communication between two or more entities such as mobile communication devices, network entities and other nodes. A communication system may be provided by one or more interconnected networks. One or more gateway nodes may be provided for interconnecting various networks of the system. For example, a gateway node is typically provided between an access network and other communication networks, for example a core network and/or a data network.

An appropriate access network allows the communication devices to access the wider communication system. Access to the wider communications system may be provided by means of a fixed line or wireless communication interface, or a combination of these. Communication systems providing wireless access typically enable at least some mobility for the users thereof. Examples of these include wireless communication systems where the access is provided by means of an arrangement of cellular access networks. Other examples of wireless access technologies include different wireless local area networks (WLANs) and satellite based communication systems.

A wireless access network typically operates in accordance with a wireless standard and/or with a set of specifications which set out what the various elements of the system are permitted to do and how that should be achieved. For example, the standard or specification may define if the user, or more precisely the mobile communication device, is provided with a circuit switched bearer or a packet switched bearer, or both. Communication protocols and/or parameters which should be used for the connection are also typically defined. For example, the manner in which communication should be implemented between the mobile communication device and the elements of the networks and their functions and responsibilities are typically defined by a predefined communication protocol.

A wireless access network typically has a plurality of access nodes for communication with mobile communication devices. Access networks may have a plurality of access points operated by a plurality of the network operators, each having one or more access points operating on different frequency. Furthermore, a communication system may have a plurality of access networks with overlapping coverage. When a mobile device moves from one access node to another access node, or from one access network to another access network, handover techniques are used to ensure that the communication is not lost as a consequence of the move.

One problem with the aforementioned arrangements is that signaling throughput is usually unevenly distributed between the access nodes and signaling is not optimized for specific application requirements. One reason for this is that current arrangements do not support an efficient mechanism to distribute the mobile communication devices among the access nodes. For example, a mobile communication device may select an access point exclusively based on the received signal quality.

Another problem with the aforementioned arrangements is that known handover techniques can be relatively slow. Thus, when a mobile device moves from one access node to another access node, or from one access network to another access network, there can be an undue delay in completing the handover to the new access node or access network. This can cause a reduction in quality of service or even loss of communication.

It is an aim of certain embodiments of the present invention to solve one or more of the aforementioned problems.

### SUMMARY OF THE INVENTION

According to an embodiment of the present invention there is provided a method comprising: comparing, in a mobile communication device, one or more application signaling requirements of a selected application with one or more link characteristics of a link between the mobile communication device and an access node of an access network; and based on said comparison, selecting at least one of: signaling, in the mobile communications device, to a handover algorithm to indicate that a handover to another access node is desired if it is determined that the application signaling requirements cannot be met by the link; and determining, in the mobile communication device, one or more transmission characteristics for the selected application based on the one or more application signaling requirements and the one or more link characteristics and transmitting a signal from the mobile communication device to the access node for the selected application using the determined one or more transmission characteristics if it is determined that the application signaling requirements can be met by the link.

According to another embodiment of the present invention there is provided a mobile communication device adapted to compare one or more application signaling requirements of a selected application with one or more link characteristics of a link between the mobile communication device and an access node of an access network, and based on said comparison, the mobile communication device is further adapted to selecting at least one of: signaling to a handover algorithm to indicate that a handover to another access node is desired if it is determined that the application signaling requirements cannot be met by the link; and determining one or more transmission characteristics for the selected application base on the one or more application signaling requirements and the one or more link characteristics and transmitting a signal from the mobile communication device to the access node for the selected application using the determined one or more transmission characteristics if it is determined that the application signaling requirements can be met by the link.

According to another embodiment of the present invention there is provided a communications system comprising: one or more access networks having one or more access nodes; and a mobile communication device adapted to compare one or more application signaling requirements of a selected application with one or more link characteristics of a link between the mobile communication device and an access node of the one or more access networks, and based on said comparison, the mobile communication device is further adapted to selecting at least one of: signaling to a handover algorithm to indicate that a handover to another access node is desired if it is determined that the application signaling requirements cannot be met by the link; and determining one or more transmission characteristics for the selected application base on the one or more application signaling requirements and the one or more link characteristics and transmitting a signal from the mobile communication device to the access node for the selected application using the determined one or more transmission characteristics if it is determined that the application signaling requirements can be met by the link.

The aforementioned embodiments provide a framework for ensuring application quality of service support on access networks. Embodiments consider the application requirements which can be mapped to link specific characteristics in real-time. Depending on the mapped requirements to link characteristics, embodiments either enable a trigger for handover to a connection manager or derive a modified transmission scenario in terms of transmission rate, re-transmission strategy, and corresponding transmission power. Finally, the derived transmission scenario either enables the successful transmission of subsequent frames or eventually triggers a hint for another access network discovery for handover to the connection manager.

Thus, embodiments control transmission and simultaneously ensure the required service level for applications over an access network.

As mentioned in the background section, another problem with prior art arrangements is that known handover techniques can be relatively slow. Thus, when a mobile device moves from one access node to another access node, or from one access network to another access network, there can be an undue delay in completing the handover to the new access node or access network. This can cause a reduction in quality of service or even loss of communication.

In order to solve this problem, in accordance with another embodiment of the present invention there is provided a method comprising: estimating a time for transferring a context from a current access node of an access network to which a mobile communication device is associated to a new access node; transferring the context from the current access node to the new access node; handing over the mobile communication device from the current access node to the new access node.

A context is a logical association allowing a mobile communication device to communicate over a network. The context may define aspects such as routing, quality of service, security, billing, etc. In prior art arrangements, when a decision is made to handover a mobile communication device from a current access node to a new access node, the context must be transferred prior to handover. The transfer of the context thus delays handover which can cause a reduction in quality of service or even loss of communication.

In contrast, in accordance with an embodiment of the present invention, the context transfer time is estimated such that the context can be transferred in good time prior to a handover being required/performed. Estimation of the context transfer time can thus enable seamless mobility.

Delayed transfer of the context in prior art arrangements eventually delays the handover which can cause a reduction in quality of service or even loss of the communication. If handover is “make before break” or “break before make”, the context transfer needs to be carried prior to handover to enable seamless mobility. A well estimated context transfer time prior to handover in accordance with embodiments of the present invention will eventually improve or maintain the quality of service. One can say that context transfer resembles a logical association but final handover is a physical association.

The context transfer time may be estimated by estimating when handover is required such that the context can be transferred before handover is required. The times at which context transfer and handover are to be performed can be estimated by comparing one or more link characteristics for a link between the target access node and the mobile communication device with one or more link characteristics for the link between the current access node and the mobile communication device. When a difference in the link characteristics passes a first threshold value, the context can be transferred. When a difference in the link characteristics passes a second threshold value, handover can be performed. The second threshold is greater than the first threshold. The first and second threshold values should be defined such that the context can be transferred prior to handover. Preferably, the first and second threshold values are defined such that the context is transferred one scanning cycle prior to handover. One or more application signaling requirements may also be taken into account in estimating when context transfer and handover should occur.

According to certain embodiments, when a link characteristic for a link between a current access node and a mobile communication device crosses a discovery threshold, a search for a new access node or network begins. Context transfer time subsequently starts when the difference between the link characteristic of a target and current node crosses a first threshold as described above. Context transfer may continue until the link characteristic for the target node crosses the discovery threshold or just above it. At the end of the context transfer there should preferably be at least one scanning interval to conclude final handover execution which occurs when the difference between the link characteristic of a target and current node crosses a second threshold.

### BRIEF DESCRIPTION OF THE FIGURES

For a better understanding of the embodiments and how the same may be carried into effect, reference will now be made by way of example only to the accompanying drawings in which:

FIG. 1 shows a schematic presentation of three wireless access systems a mobile device may use for accessing a data network.

FIG. 2 shows a partially sectioned view of a mobile device.

FIG. 3 shows a signalling flow chart in accordance with a specific embodiment of the present invention.

FIG. 4 shows a graph illustrating how the signal-to-noise ratio may vary for signalling between a mobile terminal, a current access point, and a target access point, and estimation of the context transfer time, leading up to a handover of the mobile terminal from the current access point to the target access point.

FIG. 5 shows a schematic illustration of an implementation of the present invention wherein real-time and non-real time applications are running in a mobile communication device.

### DESCRIPTION OF EXEMPLARY EMBODIMENTS

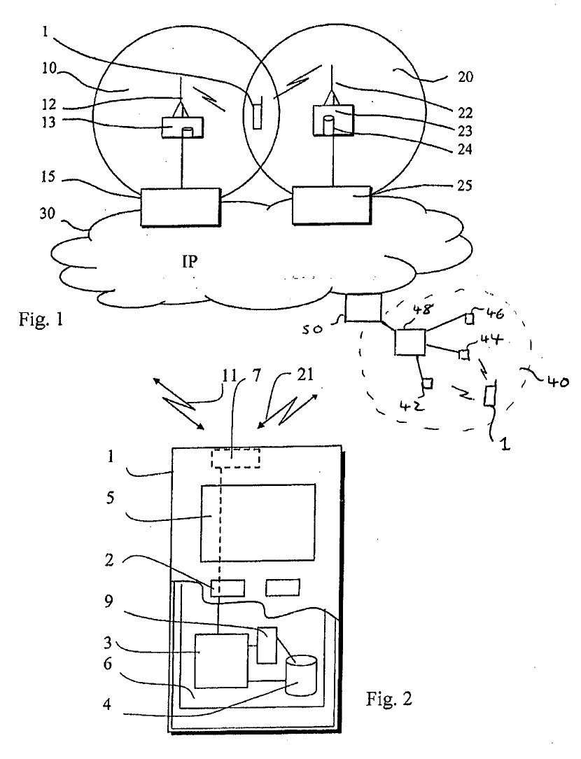

Before explaining in detail certain exemplary embodiments, certain general principles of wirelessly accessing a communication system are briefly explained with reference to FIGS. 1 and 2.

A communication device can be used for accessing various services and/or applications provided via a communications system. In wireless or mobile systems the access is provided via an access interface between a mobile device 1 and an appropriate wireless access system 10, 20, 40.

A mobile device 1 can typically access wirelessly a communication system via at least one base station and or similar wireless transmitter and/or receiver node. Non-limiting examples of appropriate access nodes are base stations 12, 22 of a cellular system and access points (APs) 42, 44, 46 of a wireless local area network (WLAN) 48. Each mobile device 1 may have one or more radio channels open at the same time and may be connected to more than one base station/access point.

A base station is typically controlled by at least one appropriate controller entity 13, 23 so as to enable operation thereof and management of mobile devices in communication with the base station. The controller entity is typically provided with memory capacity and at least one data processor.

A mobile device may be used for accessing various applications. For example, a mobile device may access applications provided in a data network 30. For example, various applications may be offered in a data network that is based on the Internet Protocol (IP) or any other appropriate protocol.

In FIG. 1 the base station nodes 12 and 22 are connected to the data network 30 via appropriate gateways 15 and 25 respectively. A gateway function between a base station node and another network may be provided by means of any appropriate gateway node, for example a packet data gateway and/or an access gateway.

Also shown in FIG. 1 is a WLAN system 48. A mobile communication device 1 functioning as a WLAN terminal is connected to a WLAN system 48 and in particular to an access point 42, 44, 46 thereof. A gateway 50 is provided for connection to an external network, for example network 30.

FIG. 2 shows a schematic partially sectioned view of a mobile communication device 1 that can be used for accessing a communication system via a wireless interface. The mobile device 1 of FIG. 2 can be used for various tasks such as making and receiving phone calls, for receiving and sending data from and to a data network and for experiencing, for example, multimedia or other content.

An appropriate mobile communication device may be provided by any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The mobile communication device 1 may communicate via an appropriate radio interface arrangement of the mobile communication device. In FIG. 2, the radio interface arrangement is designated schematically by block 7. The interface arrangement may be provided for example by means of a radio part and associated antenna arrangement. The antenna arrangement may be arranged internally or externally to the mobile device.

A mobile communication device is typically provided with at least one data processing entity 3 and at least one memory 4 for use in tasks it is designed to perform. The data processing and storage entities can be provided on an appropriate circuit board and/or in chipsets. This feature is denoted by reference 6.

The user may control the operation of the mobile device by means of a suitable user interface such as key pad 2, voice commands, touch sensitive screen or pad, combinations thereof or the like. A display 5, a speaker and a microphone are also typically provided. Furthermore, a mobile communication device may comprise appropriate connectors (either wired or wireless) to other devices and/or for connecting external accessories, for example hands-free equipment, thereto.

The mobile communication device 1 may be enabled to communicate with a number of access nodes, for example when it is located in the coverage areas of the two base stations 12 and 22 or within the coverage area of the access points 42, 44, 46 of the WLAN in FIG. 1. This capability is illustrated in FIG. 2 by the two wireless interfaces 11 and 21.

The mobile communication device 1 can be handed over from one access node, such as a base station or access point, to another access node. Furthermore, the mobile device 1 can be handed over from one access network to another access network.

All mandatory and optional data rates 6, 9, 12, 18, 24, 36, 48, and 54 Mb/s for signaling between the mobile communication device and the access nodes may be supported. Similarly, the data rates 1, 2, 5.5 and 11 Mb/s may also be supported. Furthermore, data rates higher than 54 Mb/s may be supported as speeds increase in the future.

The physical frame rate to be used for transmission of a particular frame from the mobile communication device to an access node is solely determined by the transmitting mobile communication device. This is because access nodes do not send any triggering parameters indicating the link condition to the mobile communication devices. With prior knowledge of current link capacity, a mobile communication device can determine what maximum transmission rate can be feasible over that link. The higher the rate of a physical link, the higher the encountered transmission rate will be. However, a higher transmission rate will require a higher transmitting power to maintain the communication quality. Hence, in order to determine a triggering event for handover, it would be advantageous for a mobile communication device to acquire knowledge of two parameters: (1) SNR or SIR (signal-to-noise ratio or signal-to-interference ratio) at the mobile communication device; and (2) frame error rate with respect to the derived SNR/SIR for different transmission rates. However, neither of these parameters is available to a mobile communication device in advance as they are time varying parameters.

Since information needed for the ideal radio link is not available to the mobile communication device, the present applicant proposes a method in which the conditions of the access nodes are estimated so that the mobile communication device can determine either to continue with a current access node or enable a trigger for handover to a potential new access node or access network to maintain the optimum communication quality to meet application requirements.

The present applicant has also realized that an application may have multiple media flows (e.g. audio, video, data, etc. . . . ), and different media flows will have different transmission requirements. Accordingly, transmission scenarios can be tailored according to the transmission requirements of each flow, for example, in order to maintain the optimum communication quality to meet individual flow requirements.

Furthermore, the present applicant proposes to assess the transmission requirements of a specific application when decided whether to continue with a current access node or enable a trigger for handover to a potential new access node or access network to maintain the optimum communication quality.

Further still, the present applicant proposes to adapt the transmission characteristics of the mobile communication device, such as transmission rate, according to current physical link capacity as received frame performance varies over time due to, for example, mobility, path loss, interference, etc.

Furthermore, the present applicant proposes to adapt the transmission characteristics of the mobile communication device according to the transmission requirements of a specific application.

The mobile communication device can estimate the received signal strength (RSS) by keeping track of the RSS measured from the frames sent by the access node. So long as the access node uses a fixed transmission power level for all its transmissions, the changes in RSS will be indicative of the changes in the path loss, channel performance, load on the access node, etc.

The changes in frame transmission rate in a mobile communication device determine the necessary power level for successful transmission. The transmission rate is indicative of changes in power level and so such changes may be assessed against a defined power gradient threshold and/or power threshold in order to determine whether such changes should be made.

Accordingly, it is possible to combine transmitted power control of a mobile communication device with physical link adaptation so that the derived transmission rate and proportional transmission power level can justify the need for triggering a handover event.

Thus, transmission is controlled according to adapting link quality and simultaneously ensuring the required service level for an application is met.

In accordance with an embodiment of the present invention the mobile device either determines to adapt to a new transmission rate and power for transmitting frames to its current access node or enables a trigger for a handover event. The adaptive transmission rate is justified against application requirements and therefore it is application specific. The value of the transmission rate may be derived from the received signal strength (RSS) measured from the frames/beacon received from the access node.

Certain embodiments of the present invention assume that the average received signal strength has a linear relationship with SNR/SIR. Changes in the received signal strength indicate that conditions in the wireless link between the mobile communication device and its access node are changing. Hence, depending on the application, either the mobile communication device may adapt to a new transmission rate accordingly, or the mobile communication device may enable a trigger for handover to associate with another potential access node. Meanwhile the adapted transmission rate also determines the targeted power necessary for that rate. Hence, the mobile communication device also justifies the targeted transmitted power level against a defined threshold of maximum power level over a predetermined period of time.

The physical rate adaptation can be made when an average RSS (RSS_{avg}) measured from the received frames crosses a threshold. The mobile communication device may store and update its own thresholds if transmission of a frame is successful. In one arrangement, the initial value of some or every threshold is zero, and thresholds are updated dynamically once the mobile communication device is switched on.

The thresholds indicate the minimum received signal strength (RSSₘᵢₙ) required for a particular transmission rate. The method may also determine the required power levels for use in a physical mode. In fact, this is one approach to saving the battery life of the mobile device. If received signal strength becomes lower than one of the thresholds, the mobile device will try to adapt to a new transmission rate as well as a new transmitted power level. The rationale behind considering power level is that the data frames can be transmitted using the most appropriate combination of physical transmission rate and power level, such that power consumption is minimized in proportion to physical link capacity. Since adaptation to new transmission rate also determines the required transmission power, the transmitted power should also be justified against the threshold of transmitted power level. Otherwise the trigger for handover will be enabled.

Moreover, if RSS_{avg} is significantly lower than a stored RSSₘᵢₙ, the next transmission attempt may be at a lower rate to ensure the correct reception of the frame. However, an attempt to transfer such a frame with lower transmission rate may fail. Hence, a re-transmission counter should limit subsequent re-transmission attempts with a lower transmission rate. Such detection of RSS and adaptation to proportionally lower transmission rates also provides a hint to the mobile communication device for passive scanning or to demand a site report to enable a trigger for handover. Such a hint can be determined through the frame re-transmission counter.

Thus, a set of triggering options are provided to ensure the handover operation of a mobile communication device as it approaches the limits of its current radio coverage or WLAN.

If the received trigger is indicative of RSS_{avg}, the mobile terminal may derive a trigger that adapts to a new physical rate which is proportional to the trigger indicative of a new RSS threshold and a reference value which is indicative of a threshold value specific to an application. The triggering condition is justified if the adapted physical rate exceeds (that is, goes below) the minimum threshold value of an application over a predetermined period.

If the triggering parameter is indicative of a transmission power of the mobile terminal, and the reference value is indicative of a threshold value for the transmission power, then the triggering condition is justified if the transmission power has exceeded the threshold value over a predetermined period of time.

If the mobile terminal is moving fast, path-loss may occur rapidly due to buildings, walls, etc. This situation will suddenly increase the transmission power of the mobile terminal. Hence, it may be preferable to use a gradient of power control to monitor the sudden rise in power due to path-loss. Thus, when there is a sudden rise in transmitted power threshold, or an increase in gradient of power control reaches a maximum value, trigger for handoff should occur.

If the number of re-transmission attempts is higher than a threshold value of a re-transmission counter, then the triggering condition is justified and the trigger should enable handover.

The triggering method comprises the following steps: receiving a beacon/frame indicative of a triggering parameter; determining, from the received beacon/frame, whether the associated triggering parameter justifies a triggering condition regarding a reference value; providing a signal when the triggering parameter has justified the triggering condition for handover.

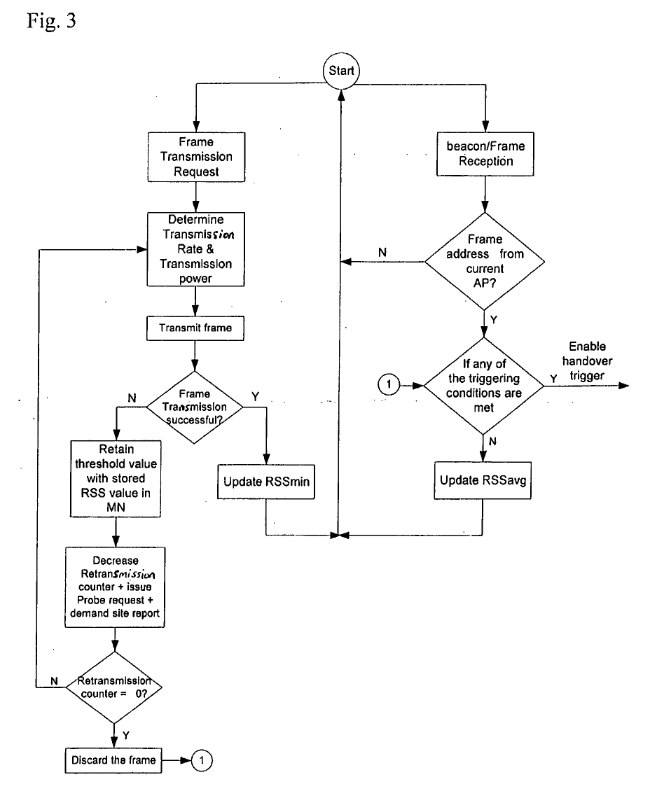

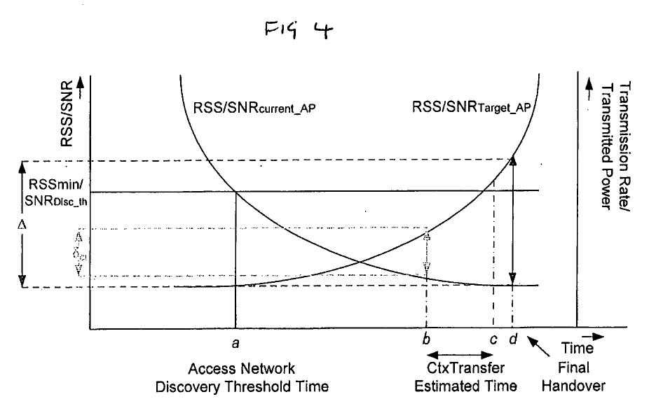

FIG. 3 shows a signaling flow chart in accordance with a specific embodiment of the present invention. The mobile terminal updates RSS_{avg} using RSS measured from a received frame/beacon (right-hand-side of flow chart). On the transmission side (left-hand-side of flow chart), the transmission rate and transmission power are determined based on RSS_{avg} and application requirements, and thresholds are updated if the frame transmission is successful. The threshold RSSₘᵢₙ is updated according to the current value of RSS_{avg} stored in the mobile communication device. A subsequent transmission may have a lower current value of RSS_{avg} than the stored RSSₘᵢₙ value. If the subsequent transmission is successful, then the RSSₘᵢₙ value will be updated with the lower RSS_{avg} value. If unsuccessful, a number of re-transmission attempts may be performed. The transmission rate may be reduced in order to achieve successful transmission. The transmission rate may be reduced only if the number of re-transmission attempts exceeds a pre-defined number of re-transmission attempts. The mobile terminal may consider the values of RSS_{avg}, RSSₘᵢₙ, frame size, and total number of permitted re-transmissions in determining the transmission rate and/or whether to trigger a handover algorithm.

Thus, from a mobile terminal point of view, WLAN traffic streams can be maneuvered by controlling transmission rate and corresponding power level. Traffic streams in other access networks such as LTE (Long Term Evolution), WCDMA (Wideband Code Division Multiple Access), HSXPA (High Speed Downlink/Uplink Packet Access), WiMAX (Worldwide Interoperability for Microwave Access) and UWB (Ultra-Wideband) can be controlled in a corresponding manner. Embodiments may be implemented in multi-interface mobile terminals which can be used in a number of different types of access network.

Irrespective of the access node performance and channel behavior, the frame error rate in a mobile communication device depends on the received frame length and its transmission rate. Hence, the mobile terminal may determine frames of different length where error rate can significantly vary from one frame length to another for a given SNR/SIR. For example, considering a maximum frame length of 1500 bytes, one can classify the different lengths as 0-200 bytes, 200-700 bytes, and 700-1500 bytes. The classification of frame length can be determined through some known statistics of network traffic. Thresholds are represented by the RSSₘᵢₙ values for ensuring transmission of a frame of the classified frame length within a particular physical mode.

Update thresholds and RSS values can be determined through the Exponential Moving Average (EMA) algorithm, shown below:

$${RSSavg}_{( k )} = ( 1 / n ) {\sum }_{i = k - n + 1}^{k} {RSS}_{( i )} ,$$

where n is relevant to a particular n-th time, and k is the arbitrary number used for a frame. Taking the above equation with (k+1)th received frame gives

$${RSSavg}_{( k + 1 )} = ( 1 / ( n + 1 ) ) {\sum }_{i = k - n + 1}^{k + 1} RSS ( i )$$

$${RSSavg}_{( k + 1 )} = ( 1 / ( n + 1 ) ) [ {RSS}_{( k + 1 )} + {\sum }_{i = k - n + 1}^{k} {RSS}_{( i )} ] , and since$$

$${\sum }_{i = k - n + 1}^{k} {RSS}_{( i )} = {nRSSavg}_{( k )}$$

$${RSSavg}_{( k + 1 )} = ( 1 / ( n + 1 ) ) ⌊ {RSS}_{( k + 1 )} + {nRRSavg}_{( k )} ⌋$$

$$then , \\ {RSSavg}_{( k + 1 )} = ( 1 / ( n + 1 ) ) {RSS}_{( k + 1 )} + ( n / ( n + 1 ) ) {RSSavg}_{( k )} .$$

Similarly, taking the above equation for the kth frame gives

RSSavg₍ₖ₎=(1/(n+1)) RSS₍ₖ₎+(n/(n+1)) RSSavg₍ₖ₋₁₎

assuming, (n/(n+1))=α [symbol] (1/(n+1))=1−α, where α≧0 and is a smoothing factor,

RSSavg₍ₖ₎=αRSSavg₍ₖ₋₁₎+(1−α) RSS₍ₖ₎

### Hence,

RSSavg=αRSSavg+(1−α)RSS

Similarly, the threshold can be determined by

Tₜₕ=αTₜₕ+(1−α)RSS

When a handover algorithm has been triggered, in both active and passive scanning modes, the scanning cycle is repeated every scanning interval Tₛ until the mobile communication device eventually finds a new access node better than the current one. For example, the signal-to-noise ratio (SNR) of transmissions from access nodes may be measured while a mobile communications device is moving away from a current access node and towards a target access node. In this case, a derived SNR value may be used as both the trigger for access node discovery (RSS goes below the RSSmin) and the criterion for access node selection and handover initiation (e.g. the SNR of a target access node must be greater by a threshold Δ than the SNR derived for the current access node).

FIG. 4 shows a graph illustrating how the signal-to-noise ratio may vary for signalling between a mobile terminal, a current access point, and a target access point, and estimation of the context transfer time, leading up to a handover of the mobile terminal from the current access point to the target access point.

At point a, the received signal strength reaches RSSmin and the signal-to-noise ratio discovery threshold RSSₘᵢₙ/SNR_{Disc}_{_{—}}ₜₕ is satisfied. This triggers the access network/node discovery process. The mobile communication device repeats the scanning cycles until it finds a target access node that provides better SNR than the current access node by an amount Δ.

Considering proactive action for context transfer, the relevant context transfer should be concluded within a scanning interval. The best time to start context transfer is at the scanning interval closest to the final handover. FIG. 4 illustrates an estimation of the scanning interval including the time when the context transfer should start.

During the access node discovery phase, until the final handover takes place, the mobile communication device estimates the time at the end of the every scanning interval

$${T}_{MN\_estimate} = \frac{Δ - ( {RSSavg}_{Target\_AN} - {RSSavg}_{Current\_AN} )}{\begin{matrix}Rate\_of \_change \_of {\_RSS}_{Target\_AN} - \\ Rate\_of \_change \_of {\_RSS}_{Current\_AN}\end{matrix}}$$

Here, the subscript “AN” refers to the access node and the subscript “MN” refers to the mobile node. RSS rate values are obtained and updated on the basis of RSS measurements performed as part of the current and previous transmission rates.

If T_{MN}_{_{—}}ₑₛₜᵢₘₐₜₑ is less than or equal to the scanning interval Tₛ (Point c in FIG. 4), the current scanning interval is likely to be the context transfer interval and the next scanning interval is for the final handover to take place. In other words T_{MN}_{_{—}}ₑₛₜᵢₘₐₜₑ ≦Tₛ.

Hence, to reduce computation the mobile communication device may start to estimate T_{MN}_{_{—}}ₑₛₜᵢₘₐₜₑ when the following conditions are met:

RSS_{Current}_{_{—}}_{AN}≦RSSₘᵢₙ

RSS_{Target}_{_{—}}_{AN}>RSS_{Current}_{_{—}}_{AN}+δ_{ct} where δ_{ct} is less than Δ.

δ_{ct} is a subset of Δ and may be selected such that

RSS_{Target}_{_{—}}_{AN}>RSSₘᵢₙ>RSS_{Current}_{_{—}}_{AN}+δ_{ct}

δ_{ct} should be selected such that there is at least one scanning interval before final handover. This can be defined from following formula:

$${T}_{s\_ct} = \frac{( Δ - {δ}_{ct} )}{( \begin{matrix}Rate\_of \_change \_of {\_RSS}_{Target\_AN} - \\ Rate\_of \_change \_of {\_RSS}_{Current\_AN}\end{matrix} )}$$

The rate values of interest can be learnt (estimated) from previous measurements.

There is no guarantee that the handover condition will be satisfied at the final scanning interval for handover to take place (point d in FIG. 4). The mobile communication device may wait until the next scanning cycle. However, in this case a longer waiting interval or lifetime for the transferred context at the new access node is required to be setup. Consequently, there may be resource wasted. In this case, a forced handover may be performed, i.e. the mobile communication device will make the handover whether the handover condition is satisfied or not. To do so, one needs to set up an appropriate waiting interval, for example, as described in the applicant's earlier patent application published as WO 2005/091663.

Embodiments of the present invention may be implemented in WLAN or in any other link layer technology such as LTE, WCDMA, HSXPA, 3 G-WiMAX, WINNER (Wireless World Initiative New Radio), etc.

Embodiments of the present invention may be utilized in conjunction with a handover algorithm. That is, embodiments of the present invention provide triggering parameters which are indicative of whether a handover may be desirable. The triggering parameters may then trigger a handover algorithm for execution of handover logic. Whether to considered one or more of the triggering parameters as criteria for actually performing a handover or not may be entirely part of the handover algorithm. To decide to actually perform a handover may depend on other factors in addition to the triggering parameters described herein.

Thus according to the embodiments described herein, a mobile communication device may receive parameters indicative of the network quality and utilize these parameters so that applications determine the proper transmission rate, transmission attempts, etc., and the system determines the proportional power level necessary. If the transmission rate, transmission attempts, etc., and the associated power level are not able to be sustained the required quality of service for an application, then further attempts are made to adapt the transmission rate and transmission power to ensure application quality. If application quality is unsustainable, a report is generated indicating possible triggering options. One can consider these triggers as software probes for monitoring quality remotely or locally.

Embodiments of the present invention consider both application and system requirements and can be made transparent to any access network.

Estimation of context transfer, handover time, and forced handovers may also be implemented by extending the usage of the triggering parameters.

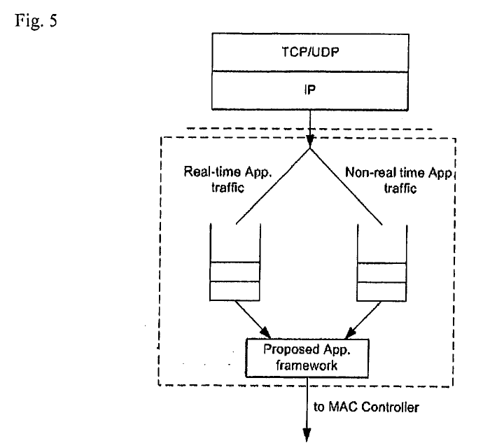

FIG. 5 shows a schematic illustration of an implementation of the present invention wherein real-time and non-real time applications are running in a mobile communication device. Traffic from these applications may comprise data packets utilizing different protocols such as IP (Internet Protocol), TCP (Transmission Control Protocol), and UDP (Universal Datagram Protocol) as illustrated in FIG. 5. The traffic thus comprises real-time and non-real time flows. Real-time and non-real time flows may also be generated by a single application.

In conventional arrangements, delay experienced by real-time application traffic increases as the number of sessions (e.g. for non-real time application traffic) increases. Eventually, the average delay may remain somewhat constant, this average delay being dependent on the queue size defined at a system or kernel level of the mobile communication device. That is, when the number of sessions is large, the system or kernel level queue becomes full resulting in some subsequent frames (e.g. real-time frames for VoIP (Voice over IP)) being dropped due to exhausted buffer capacity. Thus delay time is limited at the cost of some frames being dropped. This will affect the quality of service for the application and perceived level of user satisfaction.

Embodiments of the present invention may guarantee the delay requirements of real-time flows, independent of the number of sessions (e.g. TCP sessions), and satisfy the throughput requirements of non-real-time application traffic also.

The proposed application framework illustrated in FIG. 5 provides a traffic flow control module for applications, wherein the previously described threshold values and frame transmission counter can be selected according to the type of application traffic which is to be scheduled. That is, both link characteristics and flow requirements can be taken into account in scheduling transmissions, determining transmission characteristics, and/or triggering a handover.

Before a frame transmission request procedure is activated, each frame can be classified into real-time and non-real time traffic. From an implementation point of view, one can use UDP packet types as well as the port number found in a UDP header to classify real-time frames. For example, VoIP packets may use a pre-assigned range of port numbers for RTP (Real-Time Protocol) over UDP protocols.

In general lower layer e.g. MAC (Media Access Control) follows the FIFO (first-in-first-out) procedure. Hence, once the frame is forwarded to lower layers, further scheduling or re-ordering of frames may not be possible. Meanwhile, the transmission scheduling process is compromised if the size of the MAC queue is large. Accordingly, the proposed method indirectly controls the queue(s), utilizing, for example, the frame transmission count and frame transmission statistics for both successful and failed transmissions.

Thus, the proposed framework dynamically influences the application(s) flow requirements during ongoing communication. The proposed framework provides the mapping between transmission requirements of application flow(s) and access network characteristics to ensure application quality of service requirements. The required data processing functions may be provided by means of one or more data processors. All data processing may be provided in a mobile communication device. The data processing functions of a mobile device may be provided by separate processors, see for example entities 3 and 9 of FIG. 2, or by an integrated processor. An appropriately adapted computer program code product or products may be used for implementing the embodiments, when loaded on an appropriate processor, for example in a processor of the mobile device. The program code product for providing the operation may be stored on and provided by means of a carrier medium such as a carrier disc, card or tape. A possibility is to download the program code product to a mobile device via a data network. Implementation may be provided with appropriate software in a mobile communication device.

It is noted that whilst embodiments have been described in relation to mobile devices such as mobile terminals, embodiments of the present invention are applicable to any other suitable type of apparatus suitable for communication via a plurality of access nodes wherein a communication device can be handed over from a communication interface to another communication interface. The wireless interfaces may even be based on different access technologies. A mobile device may be configured to enable use of different access technologies, for example, based on an appropriate multi-radio implementation.

It is also noted that although certain embodiments were described above by way of example with reference to the exemplary architectures of certain cellular networks and a wireless local area network, embodiments may be applied to any other suitable forms of communication systems than those illustrated and described herein. It is also noted that the term access interface is understood to refer to any interface an apparatus configured for wireless communication may use for accessing applications.

It is also noted herein that while the above describes exemplary embodiments of the invention, there are several variations and modifications which may be made to the disclosed solution without departing from the scope of the present invention as defined in the appended claims.

1. A method, comprising:
comparing, in a mobile communication device, one or more application signaling requirements of a selected application with one or more link characteristics of a link between the mobile communication device and an access node of an access network;
based on the comparison, selecting at least one of
signaling, in the mobile communication device, to a handover algorithm to indicate that a handover to another access node is desired when it is determined that the one or more application signaling requirements cannot be met by the link; and
determining, in the mobile communication device, one or more transmission characteristics for the selected application based on the one or more application signaling requirements and the one or more link characteristics, and transmitting a signal from the mobile communication device to the access node for the selected application using the determined one or more transmission characteristics when it is determined that the one or more application signaling requirements can be met by the link.

2. The method according to claim 1, wherein the comparing comprises comparing the one or more application signaling requirements with the one or more link characteristics comprising a received signal strength of a signal received at the mobile communication device from the access node.

3. The method according to claim 2, wherein the comparing further comprises comparing the one or more application signaling requirements with the one or more link characteristics comprising the received signal strength comprising an average received signal strength.

4. The method according to claim 1, wherein the determining comprises determining the one or more transmission characteristics comprising a transmission rate.

5. The method according to claim 1, wherein the determining comprises determining the one or more transmission characteristics comprising a transmission power.

6. The method according to claim 1, wherein the determining comprises determining the one or more transmission characteristics comprising a transmission frame length.

7. The method according to claim 1, further comprising:
adapting the one or more transmission characteristics, when the transmitting the signal from the mobile communication device to the access node is unsuccessful; and
re-transmitting the signal from the mobile communication device to the access node using the adapted one or more transmission characteristics.

8. The method according to claim 7, wherein the adapting comprises decreasing the transmission rate or increasing the transmission power.

9. The method according to claim 7, further comprising:
repeating the adapting and the re-transmitting until either transmission of the signal is successful or a maximum number of re-transmission attempts is reached.

10. The method according to claim 1, wherein the comparing comprises comparing the one or more application signal requirements comprising threshold values.

11. The method according to claim 10, further comprising:
storing a plurality of threshold values in the mobile communication device,
wherein each threshold value comprises an associated corresponding application.

12. The method according to claim 11, wherein the storing comprises updating the plurality of threshold values when the signal from the mobile communication device to the access node is transmitted successfully.

13. The method according to claim 11, wherein the storing comprises storing the plurality of threshold values comprising a minimum received signal strength value.

14. The method according to claim 11, wherein the storing comprises storing the plurality of threshold values comprising a maximum transmission power.

15. The method according to claim 11, wherein the storing comprises storing the plurality of threshold values comprising a maximum transmission power gradient.

16. The method according to claim 11, wherein the storing comprises storing the plurality of threshold values comprising a minimum transmission rate.

17. The method according to claim 11, wherein the storing comprises storing the plurality of threshold values comprising a maximum number of re-transmission attempts.

18. The method according to claim 11, further comprising:
sending a signal, in the mobile communication device, to a handover algorithm to indicate that a handover to another access node is desired when one or more of the threshold values are exceeded.

19. The method according to claim 18, wherein the sending comprises sending the signal to the handover algorithm configured to utilize the one or more link characteristics as a criteria for selecting a new access node for handover.

20. The method according to claim 19, further comprising:
performing the handover from a current access node to the new access node when one or more link characteristics for a link between the new access node and the mobile communication device exceed the one or more link characteristics for the link between the current access node and the mobile communication device by a first predetermined amount.

21. The method according claim 19, wherein the sending further comprises sending the signal to the handover algorithm configured to utilize the one or more application signaling requirements as a criteria for selecting the new access node for handover.

22. The method according to claim 19, wherein the sending further comprises sending the signal to the handover algorithm configured to utilize the one or more link characteristics as a criteria for transferring a context to the new access node.

23. The method according to claim 22, wherein the transferring of the context from a current access node to the new access node is performed when one or more link characteristics for a link between the new access node and the mobile communication device exceed the one or more link characteristics for the link between the current access node and mobile communication device by a second predetermined amount which is less than the first predetermined amount.

24. The method according to claim 23, wherein the transferring is performed when the first predetermined amount and the second predetermined amount are selected such that the context is transferred one scanning cycle prior to handover.

25. The method according to claim 22, further comprising:
performing a forced handover in the cycle after transferring the context.

26. The method according to claim 22, wherein the sending further comprises sending the signal to the handover algorithm configured to utilize the one or more application signaling requirements as a criteria for transferring the context to the new access node.

27. A mobile communication device configured to:
compare one or more application signaling requirements of a selected application with one or more link characteristics of a link between the mobile communication device and an access node of an access network;
and based on said comparison, the mobile communication device is further configured to
signal to a handover algorithm to indicate that a handover to another access node is desired when it is determined that the one or more application signaling requirements cannot be met by the link; and
determine one or more transmission characteristics for the selected application on the one or more application signaling requirements and the one or more link characteristics, and transmit a signal from the mobile communication device to the access node for the selected application using the determined one or more transmission characteristics when it is determined that the one or more application signaling requirements can be met by the link.

28. A communication system, comprising:
one or more access networks comprising one or more access nodes; and
a mobile communication device configured to
compare one or more application signaling requirements of a selected application with one or more link characteristics of a link between the mobile communication device and an access node of the one or more access networks;
and based on said comparison, the mobile communication device is further configured to
signal to a handover algorithm to indicate that a handover to another access node is desired when it is determined that the one or more application signaling requirements cannot be met by the link; and
determine one or more transmission characteristics for the selected application on the one or more application signaling requirements and the one or more link characteristics, and transmit a signal from the mobile communication device to the access node for the selected application using the determined one or more transmission characteristics when it is determined that the one or more application signaling requirements can be met by the link.

29. A computer program embodied on a computer readable medium, the computer program configured to control a processor to perform:
comparing, in a mobile communication device, one or more application signaling requirements of a selected application with one or more link characteristics of a link between the mobile communication device and an access node of an access network;
based on the comparison, selecting at least one of:
signaling, in the mobile communication device, to a handover algorithm to indicate that a handover to another access node is desired when it is determined that the one or more application signaling requirements cannot be met by the link; and
determining, in the mobile communication device, one or more transmission characteristics for the selected application based on the one or more application signaling requirements and the one or more link characteristics, and transmitting a signal from the mobile communication device to the access node for the selected application using the determined one or more transmission characteristics when it is determined that the one or more application signaling requirements can be met by the link.

30. A computer program embodied on a computer readable medium, the computer program configured to control a processor to perform:
estimating a context transfer time for transferring a context from a current access node of an access network to which a mobile communication device is associated to a new access node;
transferring the context from the current access node to the new access node based on the estimation; and
handing over the mobile communication device from the current access node to the new access node.

31. A method, comprising:
estimating a context transfer time for transferring a context from a current access node of an access network to which a mobile communication device is associated to a new access node;
transferring the context from the current access node to the new access node based on the estimation; and
handing over the mobile communication device from the current access node to the new access node.

32. The method according to claim 31, further comprising:
initiating a search for the new access node when a link characteristic for a link between the current access node and the mobile communication device crosses a discovery threshold.

33. The method according to claim 31, wherein the transferring and the handing over comprise comparing one or more link characteristics for a link between the new access node and the mobile communication device with one or more link characteristics for the link between the current access node and the mobile communication device to determine when the transferring and the handing over are to occur.

34. The method according to claim 33, further comprising:
transferring the context when a difference in the link characteristics of the current access node and the new access node passes a first threshold value.

35. The method according to claim 34, further comprising:
terminating the context transfer after the one or more link characteristics of the new access node cross the discovery threshold.

36. The method according to claim 34, further comprising:
performing the handing over when a difference in the link characteristics of the current access node and the new access node passes a second threshold value.

37. The method according to claim 36, further comprising:
defining the first threshold value and the second threshold value so that the transferring of the context occurs prior to the handing over.

38. The method according to claim 37, wherein the defining comprises defining the first threshold and the second threshold value so that the transferring of the context occurs one scanning cycle prior to the handing over.

39. The method according to claim 32, further comprising:
accounting for one or more application signaling requirements in estimating when the transferring and the handing over are to be performed.

40. A mobile communication device configured to:
estimate a context transfer time for transferring a context from a current access node of an access network to which the mobile communication device is associated to a new access node;
transfer the context from the current access node to the new access node based on the estimation; and
handover the mobile communication device from the current access node to the new access node.

41. A mobile communication device, comprising:
comparing means for comparing compare one or more application signaling requirements of a selected application with one or more link characteristics of a link between the mobile communication device and an access node of an access network; and
handover means for signaling to a handover algorithm to indicate that a handover to another access node is desired when it is determined that the one or more application signaling requirements cannot be met by the link; and for determining one or more transmission characteristics for the selected application on the one or more application signaling requirements and the one or more link characteristics, and transmit a signal from the mobile communication device to the access node for the selected application using the determined one or more transmission characteristics when it is determined that the one or more application signaling requirements can be met by the link.

42. A mobile communication device, comprising:
timer means for estimating a context transfer time for transferring a context from a current access node of an access network to which the mobile communication device is associated to a new access node;
transfer means for transferring the context from the current access node to the new access node based on the estimation; and
handover means for handing over the mobile communication device from the current access node to the new access node.

43. A mobile communication device, comprising:
a comparing unit configured to compare one or more application signaling requirements of a selected application with one or more link characteristics of a link between the mobile communication device and an access node of an access network; and
a handover unit configured to
signal to a handover algorithm to indicate that a handover to another access node is desired when it is determined that the one or more application signaling requirements cannot be met by the link;
determine one or more transmission characteristics for the selected application on the one or more application signaling requirements and the one or more link characteristics, and transmit a signal from the mobile communication device to the access node for the selected application using the determined one or more transmission characteristics when it is determined that the one or more application signaling requirements can be met by the link.

44. A communication system, comprising:
one or more access networks comprising one or more access nodes; and
a mobile communication device, comprising
a comparing unit configured to compare one or more application signaling requirements of a selected application with one or more link characteristics of a link between the mobile communication device and an access node of an access network; and
a handover unit configured to
signal to a handover algorithm to indicate that a handover to another access node is desired when it is determined that the one or more application signaling requirements cannot be met by the link;
determine one or more transmission characteristics for the selected application on the one or more application signaling requirements and the one or more link characteristics, and transmit a signal from the mobile communication device to the access node for the selected application using the determined one or more transmission characteristics when it is determined that the one or more application signaling requirements can be met by the link.

45. A mobile communication device, comprising:
an estimating unit configured to estimate a context transfer time for transferring a context from a current access node of an access network to which the mobile communication device is associated to a new access node;
a transfer unit configured to transfer the context from the current access node to the new access node based on the estimation; and
a handover unit configured to hand over the mobile communication device from the current access node to the new access node.
